(19) United States
(12) Patent Application Publication
(10) Pub. No.: US 2024/0333171 A1
(43) Pub. Date: Oct. 3, 2024

(54) POWER CONVERSION DEVICE

(71) Applicant: KABUSHIKI KAISHA TOYOTA JIDOSHOKKI, Aichi-ken (JP)

(72) Inventor: Takahiro SUZUKI, Kariya-shi (JP)

(73) Assignee: KABUSHIKI KAISHA TOYOTA JIDOSHOKKI, Aichi-ken (JP)

(21) Appl. No.: 18/615,114

(22) Filed: Mar. 25, 2024

(30) Foreign Application Priority Data
Mar. 29, 2023 (JP) 2023-053389

(51) Int. Cl. H02M 7/219; H02M 3/335

(52) U.S. Cl. CPC H02M 7/219; H02M 3/33573; H02M 3/33576

(57) ABSTRACT

A power conversion device includes an AC-DC converter configured to convert input AC power into DC power and output the DC power, and a capacitor unit connected to the AC-DC converter. The capacitor unit includes a first capacitor, a second capacitor, and a fourth wire. A first end of the first capacitor is connected to a connecting point of three upper arm switching elements. A first end of the second capacitor is connected to a connecting point of three lower arm switching elements. A first end of the fourth wire is connected to a connecting point of the first capacitor and the second capacitor. When the single-phase AC power supply is electrically connected to the AC-DC converter, the fourth wire is used as an ungrounded wire by electrically connecting the second end of the fourth wire to a single-phase AC power supply.

### BACKGROUND

### 1. Field

The present disclosure relates to a power conversion device.

### 2. Description of Related Art

A power conversion device disclosed in Japanese Laid-Open Patent Publication No. 2022-11981 includes an AC-DC converter and a DC-DC converter. The AC-DC converter converts AC power supplied from an AC power supply into DC power and outputs the DC power. The DC-DC converter receives the DC power output from the AC-DC converter. The DC-DC converter transforms the input DC power and outputs the transformed power.

The AC-DC converter of the power conversion device may be configured to be electrically connectable to both a single-phase AC power supply and a three-phase AC power supply. In this case, it is preferable to reduce the difference between the voltage output from the AC-DC converter when a three-phase AC power supply is electrically connected to the AC-DC converter and the voltage output from the AC-DC converter when a single-phase AC power supply is electrically connected to the AC-DC converter. However, when the AC-DC converter is configured in this manner, it is necessary to cause the step-up ratio of the AC-DC converter when the single-phase AC power supply is electrically connected to the AC-DC converter to be significantly higher than the step-up ratio when the three-phase AC power supply is electrically connected to the AC-DC converter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a power conversion device includes an AC-DC converter configured to convert input AC power into DC power and output the DC power, and a capacitor unit connected to the AC-DC converter. The AC-DC converter includes a first serially-connected body, a second serially-connected body, a third serially-connected body, a first reactor, a first wire, a second reactor, a second wire, a third reactor, and a third wire. The first serially-connected body includes a first upper arm switching element and a first lower arm switching element that are connected to each other in series. The second serially-connected body includes a second upper arm switching element and a second lower arm switching element that are connected to each other in series. The third serially-connected body includes a third upper arm switching element and a third lower arm switching element that are connected to each other in series. The first reactor includes a first end electrically connected to a connecting point of the first upper arm switching element and the first lower arm switching element. The first wire includes a first end connected to a second end of the first reactor and a second end. The first wire is configured such that the second end of the first wire is electrically connected to a first phase of a three-phase AC power supply when the three-phase AC power supply is electrically connected to the AC-DC converter. The first wire is also configured such that the second end of the first wire is electrically connected to a single-phase AC power supply including a grounded neutral point when the single-phase AC power supply is electrically connected to the AC-DC converter, so that the first wire is used as an ungrounded wire. The second reactor includes a first end electrically connected to a connecting point of the second upper arm switching element and the second lower arm switching element. The second wire includes a first end and a second end. The first end of the second wire is connected to a second end of the second reactor. The second end of the second wire is electrically connected to a second phase of the three-phase AC power supply when the three-phase AC power supply is electrically connected to the AC-DC converter. The third reactor includes a first end electrically connected to a connecting point of the third upper arm switching element and the third lower arm switching element. The third wire includes a first end and a second end. The first end of the third wire is connected to a second end of the third reactor. The second end of the third wire is electrically connected to a third phase of the three-phase AC power supply when the three-phase AC power supply is electrically connected to the AC-DC converter. The capacitor unit includes a first capacitor, a second capacitor, and a fourth wire. The first capacitor includes a first end. The first end of the first capacitor is connected to a connecting point of the first upper arm switching element, the second upper arm switching element, and the third upper arm switching element. The second capacitor includes a first end and a second end. The first end of the second capacitor is connected to a connecting point of the first lower arm switching element, the second lower arm switching element, and the third lower arm switching element. The second end of the second capacitor is connected to the second end of the first capacitor. The fourth wire includes a first end. The first end of the fourth wire is connected to a connecting point of the first capacitor and the second capacitor and a second end. The power conversion device is configured such that, when the single-phase AC power supply is electrically connected to the AC-DC converter, the fourth wire is used as an ungrounded wire by electrically connecting the second end of the fourth wire to the single-phase AC power supply.

Other features and aspects will be apparent from the following detailed description, the drawings, and the claims.

### BRIEF DESCRIPTION OF THE DRAWINGS

FIG. 1 is a circuit diagram showing a power conversion device in a case in which a three-phase AC power supply is connected to an AC-DC converter.

FIG. 2 is a circuit diagram showing the power conversion device in a case in which a single-phase AC power supply is connected to the AC-DC converter.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A power conversion device 10 according to one embodiment will now be described.

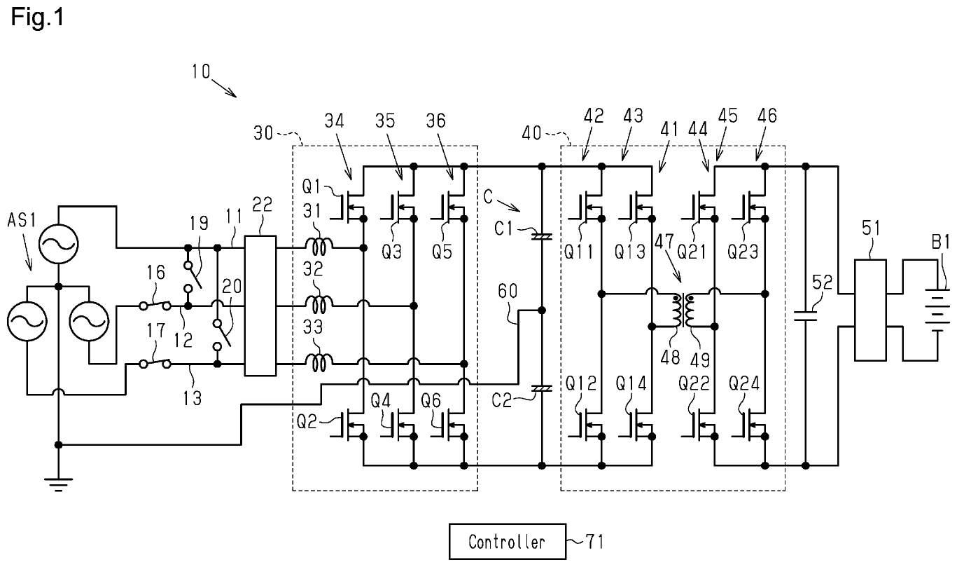

As shown in FIG. 1, the power conversion device 10 is connected to a battery B1. The battery B1 is formed by connecting multiple rechargeable batteries. The power conversion device 10 of the present embodiment is a charger that charges the battery B1 by supplying DC power to the battery B1.

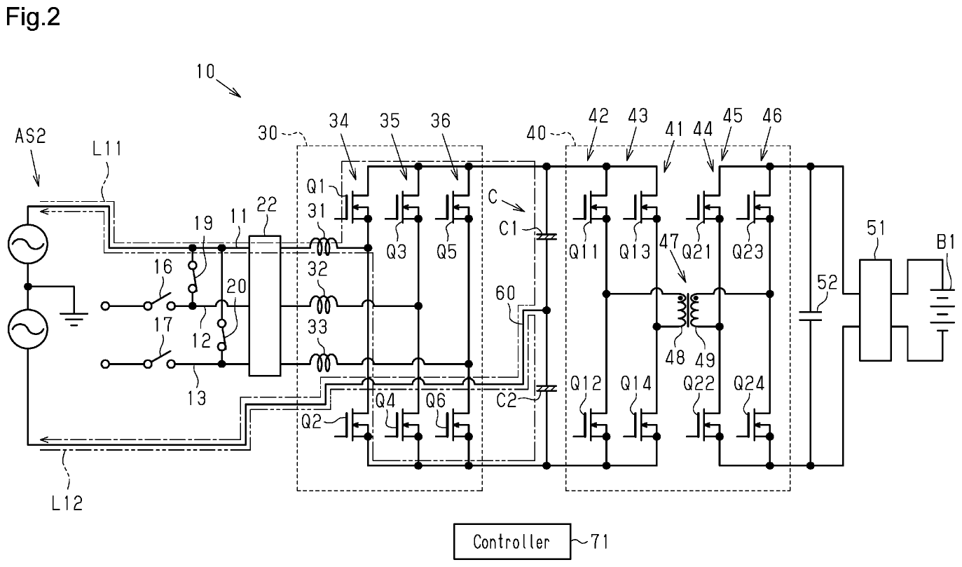

As shown in FIGS. 1 and 2, a three-phase AC power supply AS1 or a single-phase AC power supply AS2 is connected to the power conversion device 10. The power conversion device 10 converts AC power input from the three-phase AC power supply AS1 or the single-phase AC power supply AS2 into DC power and outputs the DC power. The power conversion device 10 is configured to output DC power regardless of whether the power conversion device 10 is connected the three-phase AC power supply AS1 or to the single-phase AC power supply AS2.

Case in which Three-Phase AC Power Supply is Electrically Connected to Power Conversion Device

A case in which the three-phase AC power supply AS1 is electrically connected to the power conversion device 10 will now be described. The connection method of the three-phase AC power supply AS1 is a star connection.

The power conversion device 10 includes an AC-DC converter 30, an AC filter 22, a capacitor unit C, a DC-DC converter 40, a DC filter 51, and a capacitor 52.

The AC-DC converter 30 converts the input AC power into DC power and outputs the DC power.

The AC-DC converter 30 includes a first serially-connected body 34, a second serially-connected body 35, and a third serially-connected body 36. The first serially-connected body 34, the second serially-connected body 35, and the third serially-connected body 36 are connected in parallel to each other.

The first serially-connected body 34 includes a first upper arm switching element Q1 and a first lower arm switching element Q2. The first upper arm switching element Q1 and the first lower arm switching element Q2 are connected in series to each other.

The second serially-connected body 35 includes a second upper arm switching element Q3 and a second lower arm switching element Q4. The second upper arm switching element Q3 and the second lower arm switching element Q4 are connected in series to each other.

The third serially-connected body 36 includes a third upper arm switching element Q5 and a third lower arm switching element Q6. The third upper arm switching element Q5 and the third lower arm switching element Q6 are connected in series to each other.

The switching elements Q1 to Q6 are, for example, semiconductor switching elements. A semiconductor switching element is, for example, a metal-oxide semiconductor field-effect transistor, an insulated gate bipolar transistor, or a GaN HEMT.

The AC-DC converter 30 includes a first reactor 31. A first end of the first reactor 31 is electrically connected to a connecting point of the first upper arm switching element Q1 and the first lower arm switching element Q2.

The AC-DC converter 30 includes a first wire 11. A first end of the first wire 11 is connected to a second end of the first reactor 31. When the three-phase AC power supply AS1 is electrically connected to the AC-DC converter 30, a second end of the first wire 11 is electrically connected to a first phase of the three-phase AC power supply AS1. The first phase of the three-phase AC power supply AS1 is, for example, an R-phase.

The AC-DC converter 30 includes a second reactor 32. A first end of the second reactor 32 is electrically connected to a connecting point of the second upper arm switching element Q3 and the second lower arm switching element Q4.

The AC-DC converter 30 includes a second wire 12. A first end of the second wire 12 is connected to a second end of the second reactor 32. When the three-phase AC power supply AS1 is electrically connected to the AC-DC converter 30, a second end of the second wire 12 is electrically connected to a second phase of the three-phase AC power supply AS1. The second phase of the three-phase AC power supply AS1 is, for example, an S-phase.

The AC-DC converter 30 includes a third reactor 33. A first end of the third reactor 33 is electrically connected to a connecting point of the third upper arm switching element Q5 and the third lower arm switching element Q6.

The AC-DC converter 30 includes a third wire 13. A first end of the third wire 13 is connected to a second end of the third reactor 33. When the three-phase AC power supply AS1 is electrically connected to the AC-DC converter 30, the second end of the third wire 13 is electrically connected to the third phase of the three-phase AC power supply AS1. The third phase of the three-phase AC power supply AS1 is, for example, a T-phase.

The capacitor unit C includes a first capacitor C1 and a second capacitor C2.

A first end of the first capacitor C1 is connected to a connecting point of the first upper arm switching element Q1, the second upper arm switching element Q3, and the third upper arm switching element Q5.

A first end of the second capacitor C2 is connected to a connecting point of the first lower arm switching element Q2, the second lower arm switching element Q4, and the third lower arm switching element Q6. A second end of the second capacitor C2 is connected to a second end of the first capacitor C1.

The capacitor unit C includes a fourth wire 60. A first end of the fourth wire 60 is connected to a connecting point of the first capacitor C1 and the second capacitor C2.

The power conversion device 10 includes a first switch 16. The first switch 16 is provided on the second wire 12.

The power conversion device 10 includes a second switch 19. The second switch 19 connects the first wire 11 and the second wire 12 to each other.

When the first switch 16 is on and the second switch 19 is off, the second wire 12 and the second phase of the three-phase AC power supply AS1 are electrically connected to each other. When the first switch 16 is off and the second switch 19 is on, the first wire 11 and the second wire 12 are electrically connected to each other. The first switch 16 and the second switch 19 correspond to a first switching unit capable of switching between a state in which the first wire 11 and the second wire 12 are electrically connected to each other and a state in which the second wire 12 and the second phase of the three-phase AC power supply AS1 are electrically connected to each other.

The power conversion device 10 includes a third switch 17. The third switch 17 is provided on the third wire 13.

The power conversion device 10 includes a fourth switch 20. The fourth switch 20 connects the first wire 11 and the third wire 13 to each other.

When the third switch 17 is on and the fourth switch 20 is off, the third wire 13 and the third phase of the three-phase AC power supply AS1 are electrically connected to each other. When the third switch 17 is off and the fourth switch 20 is on, the first wire 11 and the third wire 13 are electrically connected to each other. The third switch 17 and the fourth switch 20 correspond to a second switching unit capable of switching between a state in which the first wire 11 and the third wire 13 are electrically connected to each other and a state in which the third wire 13 and the third phase of the three-phase AC power supply AS1 are electrically connected to each other.

The AC filter 22 reduces noise flowing out to the three-phase AC power supply AS1. The AC filter 22 is provided on the first wire 11, the second wire 12, and the third wire 13. In the present embodiment, the AC filter 22 is provided between the connecting point of the first wire 11 with the fourth switch 20 and the first end of the first wire 11, between the connecting point of the second wire 12 with the second switch 19 and the first end of the second wire 12, and between the connecting point of the third wire 13 with the fourth switch 20 and the first end of the third wire 13. In other words, the AC filter 22 is provided between the three-phase AC power supply AS1 and the AC-DC converter 30.

The DC-DC converter 40 includes a first bridge circuit 41, a second bridge circuit 44, and a transformer 47. The first bridge circuit 41 includes two serially-connected bodies 42, 43. The two serially-connected bodies 42, 43 are connected in parallel to each other. The serially-connected body 42 includes two switching elements Q11 and Q12 connected in series. The switching elements Q11 and Q12 are, for example, semiconductor switching elements.

The serially-connected body 43 includes two switching elements Q13 and Q14 connected in series. The switching elements Q13 and Q14 are, for example, semiconductor switching elements.

A connecting point of the two switching elements Q11 and Q13 is connected to a first end of the capacitor unit C.

A connecting point of the two switching elements Q12 and Q14 is connected to the second end of the capacitor unit C.

The serially-connected bodies 42, 43 and the capacitor unit C are thus connected in parallel.

The second bridge circuit 44 includes two serially-connected bodies 45, 46. The two serially-connected bodies 45, 46 are connected in parallel to each other. The serially-connected body 45 includes two switching elements Q21 and Q22 connected in series. The switching elements Q21 and Q22 are, for example, semiconductor switching elements.

The serially-connected body 46 includes two switching elements Q23 and Q24 connected in series. The switching elements Q23 and Q24 are, for example, semiconductor switching elements.

The transformer 47 includes a first winding 48 and a second winding 49. A first end of the first winding 48 is connected to a connecting point of the two switching elements Q11 and Q12. A second end of the first winding 48 is connected to a connecting point of the two switching elements Q13 and Q14. A first end of the second winding 49 is connected to a connecting point of the two switching elements Q21 and Q22. A second end of the second winding 49 is connected to a connecting point of the two switching elements Q23 and Q24.

The capacitor 52 is a DC-link capacitor or a smoothing capacitor.

A first end of the capacitor 52 is connected to a connecting point of the two switching elements Q21 and Q23, and a second end of the capacitor 52 is connected to a connecting point of the two switching elements Q22 and Q24.

The serially-connected bodies 45, 46 and the capacitor 52 are thus connected in parallel.

The DC filter 51 is provided between the capacitor 52 and the battery B1. The DC filter 51 reduces noise included in the DC power output from the serially-connected body 46 and outputs the DC power to the battery B1.

The power conversion device 10 includes a controller 71. The controller 71 includes a processor and a storage unit. The processor may be, for example, a central processing unit (CPU), a graphics processing unit (GPU), or a digital signal processor (DSP). The storage unit includes a random-access memory (RAM) and a read-only memory (ROM). The storage unit stores program codes or instructions configured to cause the processor to execute processes. The storage unit, which is a computer-readable medium, includes any type of medium that is accessible by a general-purpose computer or a dedicated computer. The controller 71 may include a hardware circuit such as an application specific integrated circuit (ASIC) and a field programmable gate array (FPGA). The controller 71, which is processing circuitry, may include one or more processors that operate according to a computer program, one or more hardware circuits such as an ASIC and an FPGA, or a combination thereof.

The controller 71 controls the power conversion device 10. In the present embodiment, the entire power conversion device 10 is controlled by the controller 71. The power conversion device 10 may be controlled by multiple controllers.

When the three-phase AC power supply AS1 is electrically connected to the AC-DC converter 30, the controller 71 controls the first switch 16 and the second switch 19 such that the second wire 12 and the second phase of the three-phase AC power supply AS1 are electrically connected to each other, and controls the third switch 17 and the fourth switch 20 such that the third wire 13 and the third phase of the three-phase AC power supply AS1 are electrically connected to each other. Specifically, the controller 71 turns on the first switch 16, turns off the second switch 19, turns on the third switch 17, and turns off the fourth switch 20.

Case in which Single-Phase AC Power Supply is Electrically Connected to Power Conversion Device

A case in which the single-phase AC power supply AS2 is electrically connected to the power conversion device 10 will now be described. The hardware configuration of the power conversion device 10 is the same between the case in which the three-phase AC power supply AS1 is electrically connected to the power conversion device 10 and the case in which the single-phase AC power supply AS2 is electrically connected to the power conversion device 10. A neutral point of the single-phase AC power supply AS2 is grounded.

As shown in FIG. 2, when the single-phase AC power supply AS2 is electrically connected to the AC-DC converter 30, the second end of the first wire 11 is electrically connected to the single-phase AC power supply AS2. Thus, the first wire 11 is used as an ungrounded wire.

When the single-phase AC power supply AS2 is electrically connected to the AC-DC converter 30, the second end of the fourth wire 60 is electrically connected to the single-phase AC power supply AS2. Thus, the fourth wire 60 is used as an ungrounded wire.

When electrically connecting the single-phase AC power supply AS2 to the AC-DC converter 30, the controller 71 controls the second switch 19 to electrically connect the first wire 11 and the second wire 12 to each other, and controls the fourth switch 20 to electrically connect the first wire 11 and the third wire 13 to each other. Specifically, the controller 71 turns on the second switch 19 and turns on the fourth switch 20. The first switch 16 and the third switch 17 may be off or on.

When the current flowing from the single-phase AC power supply AS2 is positive, the current flows in the order of the single-phase AC power supply AS2, the AC-DC converter 30, the first capacitor C1, and the fourth wire 60, as indicated by line L11. When the current flowing from the single-phase AC power supply AS2 is negative, the current flows in the order of the single-phase AC power supply AS2, the fourth wire 60, the second capacitor C2, and the AC-DC converter 30, as indicated by line L12.

### Operation of Present Embodiment

A case will now be discussed in which the AC voltage output from the three-phase AC power supply AS1 is 200 [V]. The AC voltage is a line voltage. In this case, the peak value of the line voltage is 200×√2×√3≈490 [V].

A case will now be discussed in which the AC voltage output from the single-phase AC power supply AS2 is 200 [V]. In this case, the peak value of the AC voltage output from the single-phase AC power supply AS2 is 200×√2≈283 [V].

A case will now be discussed in which the voltage output from the AC-DC converter 30 is the same value (for example, 700 V) regardless of whether the AC-DC converter 30 is electrically connected to the three-phase AC power supply AS1 or to the single-phase AC power supply AS2. In this case, if the single-phase AC power supply AS2 is electrically connected to a conventional AC-DC converter 30 that does not include the fourth wire 60, it is necessary to increase the voltage from 283V to 700V. When the step-up ratio of the AC-DC converter 30 is increased, the loss in the reactors 31, 32, 33 increases.

In contrast, when the AC-DC converter 30 of the present embodiment is electrically connected to the single-phase AC power supply AS2, the first wire 11 and the fourth wire 60 are used as ungrounded wires. Thus, the AC-DC converter 30 and the capacitor unit C function as a voltage doubler rectifier circuit. As a result, the AC-DC converter 30 only steps up the voltage from 566 [V] (200×2×√2≈566 [V]) to the 700 V, so that the step-up ratio of the AC-DC converter 30 is reduced.

### Advantages of Present Embodiment

(1) When the single-phase AC power supply AS2 and the AC-DC converter 30 are electrically connected to each other, the first wire 11 and the fourth wire 60 are used as ungrounded wires. Thus, when the voltage output from the AC-DC converter 30 when the single-phase AC power supply AS2 is electrically connected to the AC-DC converter 30 and the voltage output from the AC-DC converter 30 when the three-phase AC power supply AS1 is electrically connected to the AC-DC converter 30 are brought close to each other, the step-up ratio of the AC-DC converter 30 is reduced as compared with the conventional AC-DC converter.

(2) When the three-phase AC power supply AS1 is electrically connected to the AC-DC converter 30, the controller 71 controls the first switch 16 and the second switch 19 such that the second wire 12 and the second phase of the three-phase AC power supply AS1 are electrically connected to each other, and controls the third switch 17 and the fourth switch 20 such that the third wire 13 and the third phase of the three-phase AC power supply AS1 are electrically connected to each other. When electrically connecting the single-phase AC power supply AS2 to the AC-DC converter 30, the controller 71 controls the second switch 19 to electrically connect the first wire 11 and the second wire 12 to each other, and controls the fourth switch 20 to electrically connect the first wire 11 and the third wire 13 to each other. Thus, when the single-phase AC power supply AS2 is electrically connected to the AC-DC converter 30, the current is input to the AC-DC converter 30 in a distributed manner, so that inexpensive switching elements can be used as the switching elements Q1 to Q6.

### Modifications

The above-described embodiment may be modified as follows. The above-described embodiment and the following modifications can be combined as long as the combined modifications remain technically consistent with each other.

The power conversion device 10 may be configured to include only the AC-DC converter 30 and the capacitor unit C.

The first switching unit may be a changeover switch. In this case, the changeover switch is an integration of the first switch 16 and the second switch 19 of the embodiment. For example, the changeover switch can selectively switch between a state in which the first wire 11 and the second wire 12 are electrically connected to each other and a state in which the second wire 12 and the second phase of the three-phase AC power supply AS1 are electrically connected to each other. The COM (common terminal) of the changeover switch is electrically connected to the second end of the second reactor 32.

The second switching unit may be a changeover switch. In this case, the changeover switch is an integration of the third switch 17 and the fourth switch 20 of the embodiment. For example, the changeover switch can selectively switch between a state in which the first wire 11 and the third wire 13 are electrically connected to each other and a state in which the third wire 13 and the third phase of the three-phase AC power supply AS1 are electrically connected to each other. The COM (common terminal) of the changeover switch is electrically connected to the second end of the third reactor 33.

The power conversion device 10 may include a switch provided on the fourth wire 60. In this case, when electrically connecting the three-phase AC power supply AS1 to the AC-DC converter 30, the controller 71 turns off the switch. When electrically connecting the single-phase AC power supply AS2 to the AC-DC converter 30, the controller 71 turns on the switch. Accordingly, the second end of the fourth wire 60 is electrically connected to the single-phase AC power supply AS2, so as to be used as an ungrounded wire.

The power conversion device 10 may include a switch provided on the first wire 11.

The power conversion device 10 does not necessarily include the first switch 16, the second switch 19, the third switch 17, and the fourth switch 20.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

The invention claimed is:

1. A power conversion device, comprising:
an AC-DC converter configured to convert input AC power into DC power and output the DC power; and
a capacitor unit connected to the AC-DC converter, wherein
the AC-DC converter includes:
a first serially-connected body including a first upper arm switching element and a first lower arm switching element that are connected to each other in series;
a second serially-connected body including a second upper arm switching element and a second lower arm switching element that are connected to each other in series;
a third serially-connected body including a third upper arm switching element and a third lower arm switching element that are connected to each other in series;
a first reactor including a first end electrically connected to a connecting point of the first upper arm switching element and the first lower arm switching element;
a first wire including a first end connected to a second end of the first reactor and a second end, the first wire being configured such that
the second end of the first wire is electrically connected to a first phase of a three-phase AC power supply when the three-phase AC power supply is electrically connected to the AC-DC converter, and
the second end of the first wire is electrically connected to a single-phase AC power supply including a grounded neutral point when the single-phase AC power supply is electrically connected to the AC-DC converter, so that the first wire is used as an ungrounded wire;
a second reactor including a first end electrically connected to a connecting point of the second upper arm switching element and the second lower arm switching element;
a second wire including a first end and a second end, the first end of the second wire being connected to a second end of the second reactor, and the second end of the second wire being electrically connected to a second phase of the three-phase AC power supply when the three-phase AC power supply is electrically connected to the AC-DC converter;
a third reactor including a first end electrically connected to a connecting point of the third upper arm switching element and the third lower arm switching element; and
a third wire including a first end and a second end, the first end of the third wire being connected to a second end of the third reactor, and the second end of the third wire being electrically connected to a third phase of the three-phase AC power supply when the three-phase AC power supply is electrically connected to the AC-DC converter,
the capacitor unit includes:
a first capacitor including a first end, the first end of the first capacitor being connected to a connecting point of the first upper arm switching element, the second upper arm switching element, and the third upper arm switching element;
a second capacitor including a first end and a second end, the first end of the second capacitor being connected to a connecting point of the first lower arm switching element, the second lower arm switching element, and the third lower arm switching element, and the second end of the second capacitor being connected to the second end of the first capacitor; and
a fourth wire including a first end, the first end of the fourth wire being connected to a connecting point of the first capacitor and the second capacitor and a second end, and
the power conversion device is configured such that, when the single-phase AC power supply is electrically connected to the AC-DC converter, the fourth wire is used as an ungrounded wire by electrically connecting the second end of the fourth wire to the single-phase AC power supply.

2. The power conversion device according to claim 1, further comprising:
a first switching unit configured to selectively switch between a state in which the first wire and the second wire are electrically connected to each other and a state in which the second wire and the second phase of the three-phase AC power supply are electrically connected to each other;
a second switching unit configured to selectively switch between a state in which the first wire and the third wire are electrically connected to each other and a state in which the third wire and the third phase of the three-phase AC power supply are electrically connected to each other; and
processing circuitry, wherein
the processing circuitry is configured to, when the three-phase AC power supply is electrically connected to the AC-DC converter, control the first switching unit such that the second wire and the second phase of the three-phase AC power supply are electrically connected to each other, and control the second switching unit such that the third wire and the third phase of the three-phase AC power supply are electrically connected to each other, and
the processing circuitry is configured to, when the single-phase AC power supply is electrically connected to the AC-DC converter, control the first switching unit such that the first wire and the second wire are electrically connected to each other, and control the second switching unit such that the first wire and the third wire are electrically connected to each other.

3. The power conversion device according to claim 1, further comprising a DC-DC converter connected to the AC-DC converter.
